(19) United States
(12) Patent Application Publication
(10) Pub. No.: US 2011/0202617 A1
(43) Pub. Date: Aug. 18, 2011

(54) METHOD AND SYSTEM FOR OBTAINING RELEVANT OPINIONS

(75) Inventors: Enaganti Bhaskar NAIDU, Sunnyvale, CA (US); Bharath Kumar YADLA, Sunnyvale, CA (US); Krishna PANYAM, Bangalore (IN); Khanderao Dattatray KAND, San Jose, CA (US)

(73) Assignee: GLOMANTRA INC., Sunnyvale, CA (US)

(21) Appl. No.: 13/028,230

(22) Filed: Feb. 16, 2011

Related U.S. Application Data
(60) Provisional application No. 61/305,042, filed on Feb. 16, 2010.

(51) Int. Cl. G06F 15/16

(52) U.S. Cl. 709/206

(57) ABSTRACT

A method, a system and a computer program product for obtaining one or more opinions relevant for a subject. A user may be enabled to select one or more individuals (corresponding to one or more sources) to receive the opinions therefrom on the subject. Further, the user may be enabled to send a message to request the individuals for providing the opinions corresponding to the selected subject. The message may be sent through one or more communication channels. Also, the individuals may be enabled to provide the opinions, corresponding to the message, through the one or more communication channels. Further, the user may be enabled to view the provided opinions. Also, the opinions relevant to the subject may be obtained from one or more public sources. The opinions received from the public sources may be aggregated, and ranked as per their relevance with respect to the subject.

### REFERENCE TO PRIORITY APPLICATION

This application claims priority from U.S. Provisional Application Ser. No. 61/305,042 filed Feb. 16, 2010, entitled “A System for Getting and Relevant Opinions from friends, experts and public networks over multiple communication channels”, which is incorporated herein by reference in its entirety.

### FIELD

The present invention relates to the field of providing opinions to a user, and more particularly, to obtaining and providing relevant opinions on a subject through one or more communication channels.

### BACKGROUND

In every field correct decision making capability of a person plays an important role. Further, to take correct decision, a person may require taking opinions on a subject from one or more individuals such as friends, family, experts, and social networks. Traditional ways of getting opinions, mainly, include calling the one or more individuals, meeting in-person and communications through E-mails. If the person fails to get opinion from the individuals through any of the ways, the person may then need to opt any other way to seek opinion therefrom. For example, if the person sends an e-mail to request his/her friend for providing an opinion for a subject, the person either needs to wait until his/her friend (receiver of the request) reads the email and provides opinion for the subject or the person needs to choose any other way to contact that individual such as the person can try contacting his/her friend by calling.

Such ways of seeking opinions forces the person to choose different channels separately. This waste loads of time of the person seeking the opinion for the subject. In such ways, firstly the person spends time and makes an effort to contact different users through different channels such as E-mail, phone call, in-person meeting and the like. Secondly, the person needs to wait for the opinions from the individual without knowing if the request has been received by the individual. Thus, this way increases the dependency of the person on the individuals receiving the request and also wastes a significant time of the person.

Further, the person may browse the internet to get the information about the subject and to seek opinions regarding the subject from the Internet. For example, to get opinion on purchasing an electronic product, the person may need to visit blogs and social networks website to know the reviews of the users for the electronic products. However, this way of browsing the Internet, to seek opinions, consumes significant time and effort of the person. Further, typically, the result of such browsing is flooded with much irrelevant information along with relevant information corresponding to the electronic product. This put an extra burden on the person to filter the relevant results for getting relevant opinions corresponding to the electronic product. This also consumes time and effort of the person. Thus seeking opinions, from the one or more individuals in abovementioned manner, is a painful, time consuming and lengthy process.

Based on the aforementioned, there is a need for an efficient and integrated method and system for obtaining opinions (for a subject) from one or more individuals, in a time efficient manner and to overcome the abovementioned shortcoming in the existing field.

### SUMMARY

To address shortcomings of the prior art, the present invention provides a method, a system and a computer program product for obtaining one or more opinions relevant for a subject. The subject may include, but is not limited to, a recommendation, corresponding to a need of a user, text content, a video, an audio, an image and the like.

An example of a method for obtaining one or more opinions relevant for a subject is provided. The method includes enabling a user to select one or more individuals to receive the one or more opinions therefrom on the subject. The one or more individuals correspond to one or more sources. The method further includes enabling the user to send a message to request the one or more individuals for providing the one or more opinions corresponding to the selected subject. The message is sent through one or more communication channels. Further, the method includes enabling the one or more individuals to provide the one or more opinions corresponding to the message. The method also includes receiving the one or more opinions provided by the one or more individuals. The one or more opinions being received through the one or more communication channel. Further, the method enables the user to view the received one or more opinions corresponding to the subject

Another example of a method for obtaining one or more opinions is provided. The method includes enabling a user to select a subject for receiving one or more opinions corresponding thereto. The method further includes processing information corresponding to the subject to identify one or more features corresponding to the subject. Further, the method includes obtaining one or more public opinions from one or more sources based on the identified one or more features corresponding to the subject. Also, the method includes processing the one or more public opinions to obtain a list of relevant one or more opinions from the one or more public opinions. Further the method provides the list of relevant one or more opinions to the user. A surprise opinion in the provided list. Further, a surprise opinion in the provided list of relevant one or more opinions is highlighted. The surprise opinion is provided on public sites or social networks by an individual corresponding to a social network of the user.

An example of a system for obtaining one or more opinions relevant for a subject is provided. The system includes a selection module configured to enable a user to select one or more individuals to receive the one or more opinions therefrom on the subject. The one or more individuals correspond to one or more sources. The system further includes a requesting module for enabling the user to send a message to request the one or more individuals for providing the one or more opinions corresponding to the selected subject. The message is sent through one or more communication channels. Further, the system includes an interaction module for providing one or more options to the one or more individuals. The one or more options being provided for enabling the one or more individuals to provide the one or more opinions corresponding to the message. Also, the system includes a receiving module for receiving the one or more opinions provided by the one or more individuals. The one or more opinions being received through the one or more communication channel. Further, the system includes an output module for enabling the user to view the one or more opinions corresponding to the subject.

An example of a system for obtaining one or more opinions relevant for a subject is provided. The system includes a selection module for enabling a user to select the subject for receiving one or more opinions corresponding thereto. The system further includes a processing module. The processing module configured to process information corresponding to the subject to identify one or more features corresponding to the subject. Further, the processing module configured to obtain one or more public opinions from one or more sources based on the identified one or more features corresponding to the subject. The system further includes a relevancy module configured to obtain a list of relevant one or more opinions from the one or more public opinions. The list of relevant one or more opinions is obtained by performing one or more functionalities on the one or more public opinions. Further, the system includes an output module configured to provide the list of relevant one or more opinions to the user. Further, a surprise opinion in the provided list of relevant one or more opinions is highlighted. The surprise opinion is provided by an individual corresponding to a social network of the user.

An example of a computer program product comprising a non-transitory computer usable medium having a computer readable program code embodied therein for obtaining one or more opinions relevant for a subject. The computer program code, when executed, performs a method that includes enabling a user to select one or more individuals to receive the one or more opinions therefrom on the subject. The one or more individuals correspond to one or more sources. Further, the method includes enabling the user to send a message to request the one or more individuals for providing one or more opinions corresponding to the selected subject. The message is sent through one or more communication channels. Further, the method includes enabling the one or more individuals to provide the one or more opinions corresponding to the message. Also, the method includes receiving the one or more opinions provided by the one or more individuals. The one or more opinions are received through the one or more communication channel. Further, the method enables the user to view the received one or more opinions corresponding to the subject.

### BRIEF DESCRIPTION OF FIGURES

In the following drawings like reference numbers are used to refer to like elements. Although the following figures depict various examples of the invention, the invention is not limited to the examples depicted in the figures.

FIG. 1 is a block diagram of an environment in accordance with various embodiments of the present disclosure;

FIG. 2 illustrates a block diagram of a system for obtaining one or more opinions relevant for a subject in accordance with one embodiment of the present disclosure;

FIG. 3 is a flowchart illustrating a method for obtaining one or more opinions relevant for a subject, in accordance with one embodiment of the present disclosure;

FIG. 4 is a flowchart illustrating a method for obtaining one or more opinions relevant for a subject, in accordance with another embodiment of the present disclosure;

FIG. 5 is a flowchart illustrating a method for obtaining one or more opinions relevant for a subject, in accordance with yet another embodiment of the present disclosure;

FIG. 6 illustrates an exemplary view of a user interface for enabling a user to select the ‘get opinion’ option corresponding to a subject, in accordance with one embodiment of the present disclosure; and

FIG. 7 illustrates an exemplary view of a user interface for enabling a user to select one or more individuals for obtaining opinions therefrom, in accordance with one embodiment of the present disclosure.

### DETAILED DESCRIPTION

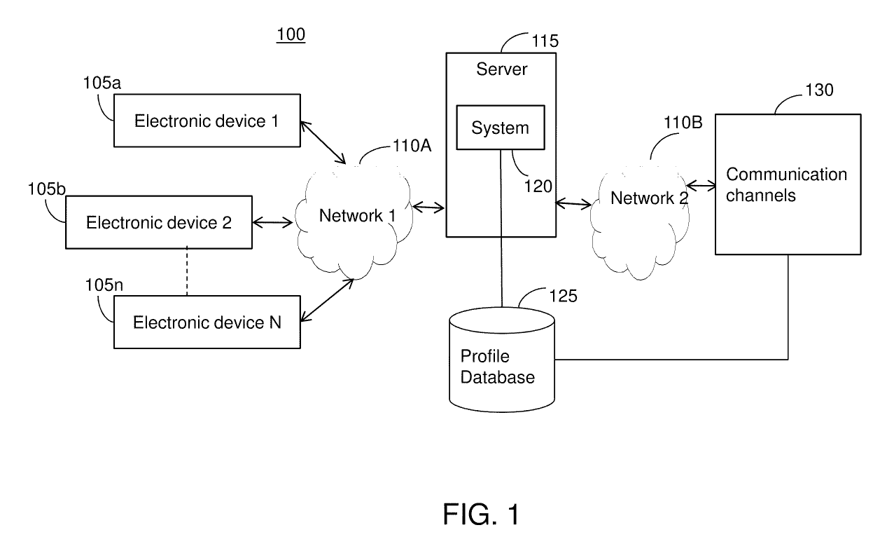

FIG. 1 is a block diagram of an environment 100 in accordance with various embodiments of the present disclosure. The environment 100 includes one or more electronic devices such as an electronic device 1 105a, an electronic device 2 105b, . . . to an electronic device n 105n, a network 110A and a network 110B, a server 115, a system 120, a profile database 125 and communications channels 130.

A user can interact with the system 120 using an electronic device such as the electronic device 105a. Examples of the electronic devices include, but are not limited to, desktop, laptop, hand held computers, mobile phone, personal digital assistant (PDA), smart phones, digital television (DTV), internet protocol television (IPTV), and play stations. The user may utilize the system 120 to receive one or more opinions on a subject. The subject may include, but is not restricted to, a recommendation for a product or a service corresponding to a need of the user, a video, an audio and an image. In an embodiment, the subject can be a free form text or a text as a reference to other information on which an opinion is sought. For example, but not restricted to, News, article, blog, product information, recommendations, audio file, video file, picture or URL of such information.

The user may access the system through a network such as network1 110A. The user may select a recommendation from available one or more recommendations to seek opinions thereon. In an embodiment, the user may receive the one or more recommendations by utilizing the system 120.

The system 120 can be uploaded to the server 115. Furthermore the system 120 can also be installed as an application on, for example, but not limited to, social networking sites, private sites and public sites. Moreover, the system 120 can also be a standalone module that can be used to obtain one or more opinions relevant for the subject. The opinions, on the subject, may be obtained by the user using a User Interface (UI) generated by system 120. In one embodiment, the system 120 may provide a Graphical User Interface (GUI) to enable the user to select a subject from available subjects provided by the system 120. Further, the GUI may enable the user to select the subject for obtaining the opinions thereon. In one embodiment, the system may enable the user to obtain opinions from one or more individuals that may be selected by the user. The user may select the individuals from a contact list that may be maintained in the profile database 125 of the user. The contact list may be maintained by the user by adding friends, family members, experts or any other individual directly from his/her own personal contacts or by importing contacts from any social network, such as the Facebook, Twitter, Linked-in, Orkut and the like. In another embodiment, the system may find public opinions from one or more sources such as the contact list of the profile database 125, one or more social networks (such as Facebook, twitter, and the like), blogs, or any other public website.

In another embodiment, the system may be implemented through other applications. In such cases, the applications may provide the Graphical User Interface (GUI) to enable the user to obtain the opinions, such as public opinions or opinions from the one or more individuals of the user's contact list, from the system 120. Further, the user may select the individuals from the contact list to seek opinions therefrom. Further, the system may recommend one or more individuals from whom the user may seek opinions corresponding to the subject. The system may recommend the individuals based on matching of information corresponding to the subject and information associated with the recommended individuals.

Additionally, the system 120 may provide various features (options) to the selected individuals to provide opinions, on the subject, to the system 120. Such features may be provided to the individual when a request for opinions is sent to the individuals.

In one embodiment, the user may register with the system 120 to obtain opinions relevant to the subject. Further, the user may access the system 120 by login to the system 120 by providing authenticated details to the system 120. Further, the user may access the system 120 by utilizing the network 1 110A. Examples of network 1 110A may include, but are not limited to, internet, Ethernet, local area network (LAN), wireless, wide area network (WAN), metropolitan area network (MAN), and small area network. The system 120 may obtain or may enable the user to obtain the one or more opinions for the subject. The system 120 may enable the user to get relevant opinions for the subject from one or more individuals present in the contact list of the profile database 125 of the user. Further, the system 120 may search public opinions from social network of the user and from various public sources such as public websites relevant to the subject.

The system 120 may enable the user to request one or more individuals for obtaining one or more opinions therefrom. The request may be sent through the communication channels 135. The communication channels 135 may include E-mails, Short Messaging Services (SMS), MMS, various social networking websites such as twitter, Facebook and the like. The request for opinions may be sent by utilizing the network 2110B

Further, the system 120 may receive the opinions through one or more communication channels via the network 2 110B.

In an embodiment, the system 120 may search for public opinions corresponding to the subject by utilizing searching tools (not shown), to perform a search corresponding to the request (for opinions) to obtain the public opinions. The searching tools may include, but is not limited to, various search engines such as ‘Google’ and ‘Yahoo’ and various websites such as RateItAll, Yelp, Angie's List and various websites for public blogs corresponding to the subject. The social networking web sites may include, but are not restricted to, Orkut, Facebook and twitter, public networking web sites, domain specific sites and private web sites. In an embodiment, the searching tools may also have access to various databases. Various databases may store the opinions associated with the subject for future references. Further, the databases may be utilized by the searching tools to obtain the opinions associated with the subject. Further, the opinions obtained by the searching tools may be provided to the user by the system 120.

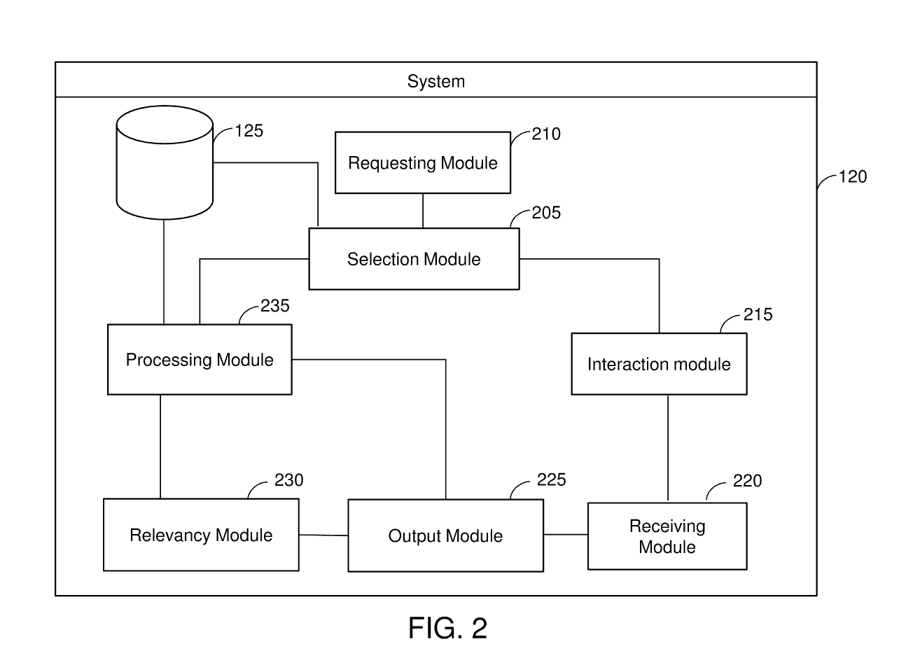

FIG. 2 illustrates a block diagram of a system, such as the system 120, for obtaining one or more opinions relevant for a subject in accordance with one embodiment of the present disclosure. In an embodiment, the system 120 is an online system that is accessible by a user through a network, such as Internet (as explained earlier in conjunction with FIG. 1). The system 120 includes a selection module 205, a requesting module 210, an interaction module 215, a receiving module 220, an output module 225 and a relevancy module 230. Further, the system 120 includes a processing module 235 and a profile database such as the profile database 125.

The system 120 may be utilized to receive opinions, for a subject, from other users such as one or more individuals from contact list of the profile database 125 and from one or more social networks such as various public websites, networking sites such as Facebook, Twitter and the like. In an embodiment, the system 120 may enable the user to request the one or more individuals to provide one or more opinions. In another embodiment, the system 120 may search for one or more opinions corresponding to the subject. The opinions may enable the user to take decision corresponding to the subject. For example, if the subject corresponds to good north Indian restaurants in San Francisco and the user has more than one name for north Indian restaurant, then the user may seek opinions regarding a particular north Indian restaurant to decide the best north Indian restaurant among the available names of the north Indian restaurants. The user may request the other users for providing opinions corresponding to the particular restaurant. As a result, the user may receive opinions, from the other users, that may include information corresponding to the particular north Indian restaurant that the user has requested to provide opinion for.

The selection module 205 may enable a user to select one or more individuals to receive one or more opinions therefrom on the subject. The subject may correspond to recommendation obtained from the system 120 based on need of the user. The system 120 may provide one or more recommendations to the user corresponding to the need of the user. Further, the selection module 205 of the system 120 may enable the user to select one of the one or more recommendations to seek opinions thereon. Further, the subject may include a URL, audio, video, an image, a message, an e-mail, news article, blog entry and the like, for which the user may wish to seek opinion for.

Further, the one or more individuals may correspond to one or more sources such as a contact list maintained by the profile database 125 (as explained earlier) of the user. The contact list may be maintained by the user by adding friends, family, experts and other users directly or from one or more social networks such as Facebook, Twitter, Linked-In, Orkut and the like. The system 120 can provide direct way to the user to enable the user to access the social networks to import contacts therefrom to upgrade the contact list.

Further, the selection module 205 may enable the user to select the subject from available subjects for seeking opinions from the individuals. Further, in an embodiment, the system 120 may provide a Graphical User Interface (GUI) to enable the user to enter the subject explicitly by the user. In this case, the user need not select the subject from the available subjects provided by the system 120 and may be enabled to provide any subject explicitly to seek opinions thereon. The system 120 may provide a graphical User Interface (GUI) to the user to enable the user to interact with the system.

Further, in an exemplary embodiment, the GUI may provide a web page containing a button for enabling the user to seek opinions from the other users. Also, the system 120 may be installed on an electronic device such as a mobile device that may enable the user to ask for the opinions by utilizing an option in the electronic device. Further, the opinions through the electronic device may be sought depending upon type of the device. The system 120 may be utilized as a service that may be programmatically invoked for seeking the opinions on the subject.

The selection module 205 may enable the user to select the one or more individuals to send a request for providing the opinions on the subject. In an embodiment, the user may select the individuals based on the subject. For example, if the subject is related to a technical domain, then the user can select a person who is an expert in the technical field. Further, if the user wants to receive opinions on a restaurant then the user may select friends or family members, from the contact list, to request for providing opinions on the subject.

Further, in an embodiment, the selection module 205 may provide recommendations to the user for selecting one or more individuals to seek opinions therefrom. The selection module 205 may recommend the individuals, for seeking opinions therefrom, when information associated with the individuals corresponds to the subject. For example, if the subject corresponding to the need of finding hospital for Mitral Valve Replacement for heart treatment, the selection module 205 may search the profile database and social network for finding individuals related either to this treatment or to the hospital for Mitral Valve Replacement for heart treatment. Further, in this case, the selection module 205 may search the profiles associated with the individuals and recommend the individuals based thereon. For example, if a profile corresponding to an individual provides information such as the individual is cardiac surgeon for Mitral Valve Replacement or Heart specialist, then the selection module 205 may recommend the individual to seek opinions therefrom.

The requesting module 210 may enable the user to send a message to request the one or more individuals for providing the one or more opinions corresponding to the selected/entered subject. The user may be provided with a template for writing a message for the individuals for sending a request (for opinions) thereto. The template may be pre-filled by the system 120 that may directly be utilized by the user to send the request to the individuals. In an embodiment, the system may enable the user to formulate the message in your own ways to request the individuals.

The requesting module 210 may send the message by utilizing the adapter to send the message through one or more communication channels such as, but not restricted to, HTTP, SMTP, Wireless, telephony. For example, the message may be sent to a smart phone of the individuals through various ways such as SMS, MMS, and E-mails. Further, the message may be sent over the network, such as Internet, as explained in conjunction with FIG. 1.

Additionally, the requesting module 210 may enable the user to specify additional information like urgency of the need for which opinions are being sought and for how long the opinions needs to be monitored from the sources and the like.

Based on the message (sent to the individuals), the individuals may respond by providing opinions corresponding to the subject of the message. The interaction module 215 may provide options to enable the individuals to provide opinions to the user. The options may include, but are not restricted to, URLs or direct links that may enable the individual to visit a web page to provide opinions to the user. Further, the web page (corresponding to the link) may provide one or more options such as ‘Go for it’, ‘ditch it’, ‘no clue’ and the like for enabling the user to respond corresponding to the subject. Further, the web page may enable the individual to write a personalize message for providing opinions for the subject. Further, in an embodiment, the individuals may be enabled to provide the opinion through any of the communication channels (as described earlier).

The receiving module 220 is configured for receiving the one or more opinions provided by the individuals. The receiving module 220 may receive one or more opinions through the one or more communication channel. Further, the receiving module 220 may monitor inbound channels for receiving the opinions. The receiving module 220 may monitor the opinion responses from various sources. The responses may be stored a database along with information corresponding to the various sources. Further, the database may store the source of the opinions such as information corresponding to the individuals from where the opinions are received.

In an embodiment, on the user's selection of the subject, the processing module 235 may process information corresponding to the subject to identify one or more features corresponding to the subject. The one or more features may include, but are not restricted to, entities and domains corresponding to the subject. The information corresponding to the subject may be parsed to identify the entities, domain and other information corresponding to the subject. The identified features may be utilized by the processing module 235 to obtain one or more public opinions from one or more sources.

In an embodiment, the processing module 235 may process title and excerpts of details corresponding to the subject. The processing module 235 may process the information by entity extractions and key phrase detection corresponding to the subject. One approach for key phrase detection may be based on using external search providers. These search providers, when returns the resultant identified key phrases, the key phrases may be matched with the available content and rank them as per their ranking algorithms. The top ranked phrases may be used as key phrases and passed to entity databases, like Freebase or dbpedia or local Glomantra database, to identify the entities in the phrases. Identified entities like movie, restaurants, people, business, service provider etc. may be used for searching comments as public opinions from various social networking websites and other public sites.

In another embodiment, the entities may be extracted through algorithms based on RMMS. In an embodiment, the RMMS algorithm may identify the entities by comparing text string present in the subject with information, regarding entities, present in various sources. Examples of various sources include, but not limited to, Dbpedia, Wikipedia, domain specific sites and the like. These extracted entities may then be passed iteratively to the entity databases or internal/external search tools to find any matching entities. The matched entities may then be passed to the social/public web sites for comments/opinion searches.

After receiving searched opinions from public/social web sites, the processing module 235 may perform post processing thereon. In an embodiment, the post processing may include matching the key phrases by using text matching that may match the keywords.

Further, the relevancy module 230 may obtain relevant order of the opinions obtained from the individuals. The opinions may be ordered based on relevancy of the opinions corresponding to the subject. The relevant order of the one or more opinions may be obtained by performing one or more functionalities thereon. The functionalities may include, but are not limited to, aggregation of the opinions and ranking of the opinions based on relevancy of the opinions corresponding to the subject.

The relevancy module 230 may analyze the received opinions for relevance and rank the opinions based on value of the opinions with respect to the subject. The opinions may be ranked by using one or more algorithms. In an embodiment, the value of the opinions may be determined by the source of the opinions that is the individual from where the opinions have been received. For example, if the individual is an expert of the subject then the opinion provided by the individual may be considered as valuable and thus may be ranked with high value. Further, an opinion from an individual such as a friend of the user may be ranked based on the level of affinity of the user with the friend.

Similarly, the ranking may be performed based on past experience of the user. For example, if the user had opted for the same subject, in the past, for which the opinion was received from the particular individual. In such cases, the relevancy module 230 may learn the past behavior of the user corresponding to the same subject. Correspondingly, the relevancy module 230 may mark the opinion provided by that particular individual with higher rank. Thus, the relevancy module 230 may obtain a ranked list of the opinions.

It may be appreciated that the relevancy module 230 is not restricted to above mentioned ways for providing ranks to the opinions. The relevancy module 230 may learn continuously from the behavior of the user corresponding to selecting the subject and accepting an opinion for the subject.

Further, the output module 225 may enable the user to view the received opinions corresponding to the subject. In an embodiment, the output module 225 may display the opinions to the user. The user may view the opinions by accessing the GUI of the system 120. Further, the output module 225 may provide an alert to the user corresponding to the opinions. The alert is provided to the user when the opinions are received from the individuals. Further, in an embodiment, the alert may be provided through various ways. For example, by emailing to the user or by sending a message to the user on the user's mobile phone. This alert may notify the user about the received opinions. Further, the user may view the opinions through various communication channels. For example, the user may login to the system 120 to view the opinions. Also, the user may access the opinions by utilizing his/her mobile phone, based on the type of the mobile phone.

Further, the opinions are viewed in context of activity of the user. For example, the activities may include, but are not restricted to, online buying of a product, reading an article or watching a picture album.

In an embodiment, the processing module 235 may search various public sources such as the user's social network and various public websites for obtaining public opinions for the subject. A type of public opinion can be online rating and review sites for example, but not restricted to, RateItAll, Yelp, and Angie's List. The features of the subject may be matched with information available in public opinions (as explained earlier). Based on this, the processing module 235 may extract public opinions, from the social networking web sites and the public web sites, relevant for the subject.

The relevancy module 230 may perform functionalities on the obtained one or more public opinions. For example, the relevancy module 230 may aggregate the one or more public opinions obtained from the one or more sources to form an aggregated list of the public opinions. Further, the relevancy module 230 may rank the public opinions of the aggregated list to form a ranked list. As explained earlier, the relevancy module 230 may rank the opinions (public opinions) based on relevancy of each of the public opinions corresponding to the subject. Further, top ranked public opinions may be selected from the ranked list to obtain the list of relevant one or more opinions.

Further, the list of relevant one or more opinions may be provided to the user by the output module 225, as explained earlier. Further, the output module 225 may highlight a surprise opinion in the provided list of relevant one or more opinions. The surprise opinion may include an opinion that may be obtained by the processing module 235 and may be provided on public/social networking sites by an individual that is available in the social network of the user. As the processing module 235 may obtain such opinions, from the individual corresponding to the user's social network, without the knowledge of the user, the output module 225 may highlight the opinion.

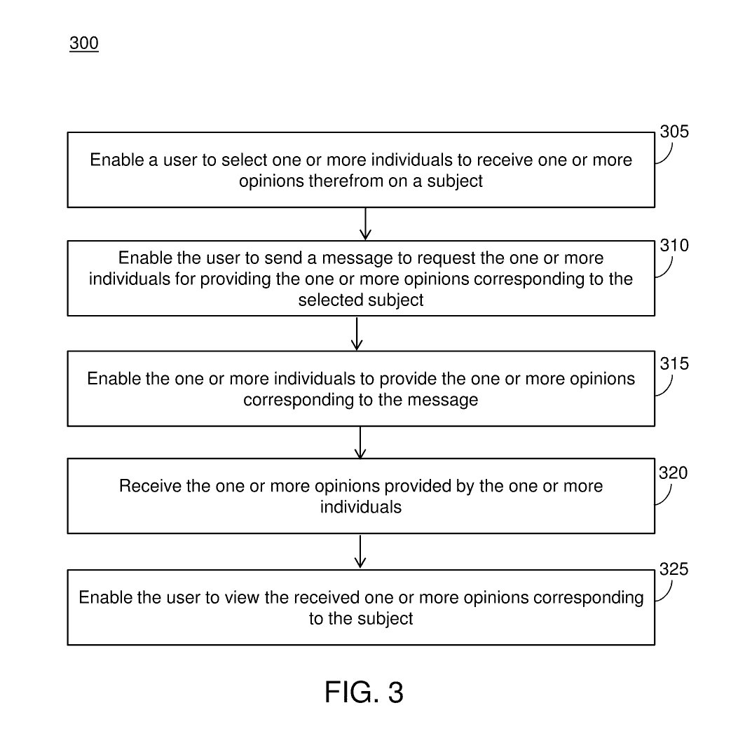

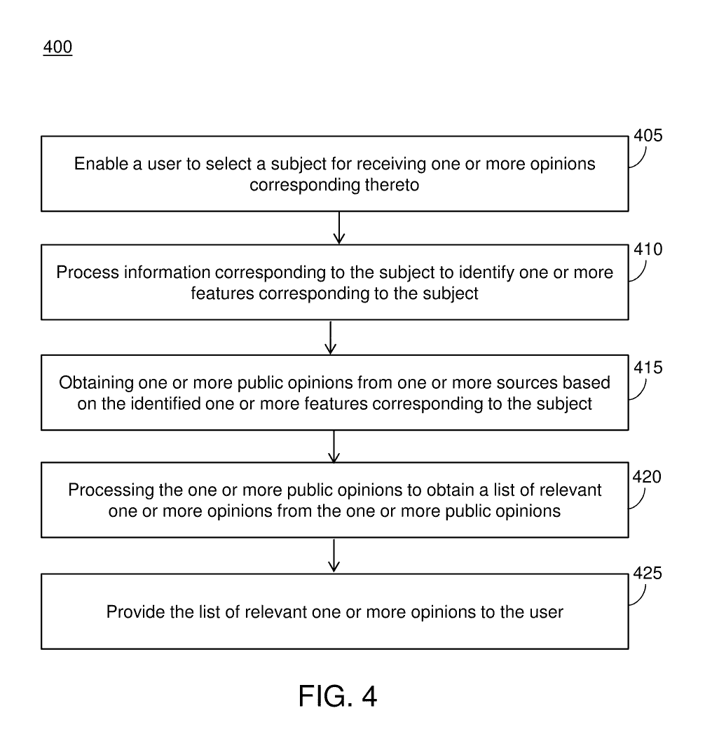

The system 120 and functionality of its components may be understood more clearly when read in conjunction with FIG. 3 and FIG. 4.

FIG. 3 is a flowchart illustrating a method 300 for obtaining one or more opinions relevant for a subject, in accordance with one embodiment of the present disclosure. Specifically, the method 300 may enable a user to obtain opinions from one or more individuals corresponding to profile database, such as the profile database 125, of the user or from the user's social network or experts on the subject's matters. Initially, the subject may be selected by the user to obtain opinions thereon. The order and number of steps in which the method 300 is described is not intended to be construed as a limitation. The description corresponding to FIG. 3 may be understood more clearly when read in conjunction with FIG. 1 and FIG. 2.

At step 305, the user may be enabled to select a subject on which the user needs opinion. The subject may be of various types based on type of the opinions sought by the user. For example, the subject may be a text, an audio, a video and an image. Further, in case of text based opinion, subject can be a free form text or a text as a reference to other information on which an opinion is sought. For example, but not restricted to, News, article, blog, product information, recommendations or URL of such information. Further, the subject may be a video streaming using QIK, You Tube or any other video sources. Similarly, the subject may contain audio such as voice mail, voice SMS, music, speech and the like. Also, the subject may be a picture or an image, picture of a gift to buy and any other image.

Further, at step 305, the user may be enabled to select one or more individuals to receive the one or more opinions therefrom on the subject. The one or more individuals correspond to one or more sources such as a contact list of profile database, such as the profile database 125, maintained by the user. The user's contact list may be consolidated from various sources, for example, Face book friends, Gmail list, Yahoo mail, iPhone contacts, outlook or local contacts or any other contact manager or source.

Further, the user may receive recommendations for selecting the individuals for seeking opinions therefrom. The recommendations for an individual may be provided to the user when information associated with the individual corresponds to the subject. For example, if the subject corresponds to movie and profile information of an individual gives information about the individual's interest in movies, then the individual may be recommended for being selected by the user to seek opinion therefrom.

At step 310, the method 300 enables the user to send a message to request the one or more individuals, as selected at step 305, for providing the one or more opinions corresponding to the selected subject. The message may be sent along with the subject or a reference to the subject, and the user's comment. The user's comment may be to request the individuals for providing opinions corresponding to the subject. The user may be provided with a template of a message that may be sent as it is to the individual for requesting the individuals for providing the opinions corresponding to the subject. Further, the user may be enabled to formulate the message as per his/her own wish.

The message may be sent to the individuals through one or more communication channels. The communication channels could be communication channels like email, SMS, MMS, and the like. In an embodiment, the communication channels may include social networking web sites or other web sites, such as Facebook, Twitter, Ning, LinkedIn and the like, that may enable the user to contact the friend or expert individually.

The request may be presented to the individuals by providing the message or by providing a reference to the message. The reference may include a link that may be followed by the individuals to provide opinions to the user, in response to the request. At step 315, the individuals, on receiving the request, may be enabled to provide one or more opinions corresponding to the message. The individuals may be provided with one or more quick options that may enable the individuals to provide opinions. Such options may include, but are not restricted to, “Go for it”, “Ditch it”, “No Clue” and the like. In an embodiment, the individual may provide the opinions through email or through social network. For example, the friend or expert individuals may provide the opinions via email, or social networking person-to-person communications or web form.

At step 320, the one or more opinions may be received through the individuals. The one or more opinions may be received through one or more communication channels. For example, the individual may send the opinions through different communication channels such as emails, SMS and the like.

Further, in an embodiment, the opinions may also be gathered from a Friend-of-Friend. For this, upon receiving an opinion request from the user, the user's friend may be enabled to share the opinion request to his/her friends. By this, any friend of the user's friend may directly respond to the user through provided options.

Further, one or more functionalities may be performed on the received opinions. The one or more functionalities may be performed to obtain relevant order of the one or more opinions based on relevancy of the one or more opinions corresponding to the subject. The one or more functionalities may include at least one of aggregating the opinions, providing ranks to the opinions based on the relevancy of the opinions with respect to the subject. The relevancy of the opinions may be determined by utilizing one or more algorithms. Further, in an embodiment, the relevancy of the opinions may be determined by obtaining information corresponding to the project. The information may include features such as entities, domains and like corresponding to the subject. Such information may be utilized to determine relevancy of the opinions for the subject. Further, the opinions may be ranked based on the relevancies of the opinions.

At step 325, the ranked opinions may be provided to the user to enable the user to view the received one or more opinions corresponding to the subject. Further, the user may be provided with alert information when the user receives opinions from the requested individuals. The alert may be provided to the user in various ways. For example, through SMS, by providing visual clue on the web page that was utilized by the user for searching the opinions corresponding to the subject. The user may be enabled to view the received opinions through one or more communication channels. For example, the user may access the opinions through E-mail or by accessing a web page corresponding to the opinions. Further, the ways to access the opinions are not limited to communication channels as described herein this disclosure. Further, various steps of method 300 may be understood more clearly when read in conjunction with FIG. 2.

FIG. 4 is a flowchart illustrating a method 400 for obtaining one or more opinions relevant for a subject, in accordance with another embodiment of the present disclosure. Specifically, the FIG. 4 provides a method for providing public opinions, obtained from the one or more public sources, to the user. The order and number of steps in which the method 400 is described is not intended to be construed as a limitation. The description corresponding to FIG. 4 may be understood more clearly when read in conjunction with FIG. 2 and FIG. 3.

At step 405, the user may be enabled to select a subject for receiving one or more opinions corresponding thereto. The subject may include, but is not restricted to, a recommendation corresponding to a need of the user, an audio, a video, an image. For example, the user may be provided with one or more recommendations corresponding to the need of the user. The user may seek opinion for a recommendation by selecting the recommendation from the one or more recommendations. Further, information corresponding to the subject is described already in conjunction with FIG. 3, thus is not repeated here for the sake of brevity.

At step 410, the information corresponding to the subject may be processed to identify one or more features corresponding to the subject. The one or more features corresponding to the subject may include, but are not restricted to entities and domains of the subject. For example, if the subject corresponds to “Sneha Indian restaurant in Sunnyvale”, then the entities like the name of the restaurant, Sunnyvale, ‘Indian’ and ‘restaurant’ may be identified. Further the domain ‘restaurant’ may be selected. The identification of the one or more features may be understood more clearly when read in conjunction with FIG. 2.

At step 415, based on these features, the one or more public opinions may be obtained from one or more sources. The one or more sources may include, but are not limited to, an online rating and review sites for example, but not restricted to, RateItAll, Yelp, Angie's List and the like. In an embodiment, the features of the subject may be matched with content of online rating and review sites to search the one or more public opinions relevant for the subject. Further, while searching the public opinions expressed in various public sites, a source of each public opinion may also be searched. In an embodiment, the sources of the public opinions may be stored in a database for future references. In an embodiment, if the source of any of the public opinions is same as a contact of the user's contact list or from the user's social network, then such public opinion may be highlighted. The source of public opinion that is matched with any of the contacts of the user's contact list, is highlighted to present the opinion as a surprise as such opinion may be obtained without the knowledge of the user. Further, such opinions may be given higher relevancy.

At step 420, the one or more public opinions may be processed to obtain a list of relevant one or more opinions from the one or more public opinions. The list of relevant one or more opinions may be obtained by performing one or more functionalities on the one or more public opinions. The one or more functionalities may include aggregating the one or more public opinions obtained from the one or more sources to form an aggregated list of the public opinions. Further each public opinion of the aggregated list may be ranked to form a ranked list. The public opinions may be ranked based on relevancy of each of the public opinions corresponding to the subject.

The relevancy of the public opinions may be determined through various ways. In an embodiment, the public opinions may be ranked by determining relevancy of the public opinions through one or more heuristic algorithms. For example, the heuristic algorithm may consider factors like affinity to the friend, repeat inquires as well as past activities of the user such as previous consideration of the subject (by the user) based on opinion from a particular source, previous opinions from the friend. Further, in case of opinions from experts, a ranking captured from previous services may be considered to provide ranking to the public opinions of the aggregated list. Further, the surprise opinion (as explained earlier) that may be obtained, while searching the public opinions, without the knowledge of the user, may be given a higher relevancy and thus high ranking may be provided to the surprise opinion.

Further, the one or more functionalities may include selecting top ranked public opinions from the ranked list to obtain the list of relevant one or more opinions.

At step 425, the list of relevant one or more opinions may be provided to the user. in an embodiment, the surprise opinion in the provided list of the relevant opinions may be displayed as highlighted to the user. the user may access the relevant opinions through one or more communication channels, as explained earlier in conjunction with FIG. 2 and FIG. 3.

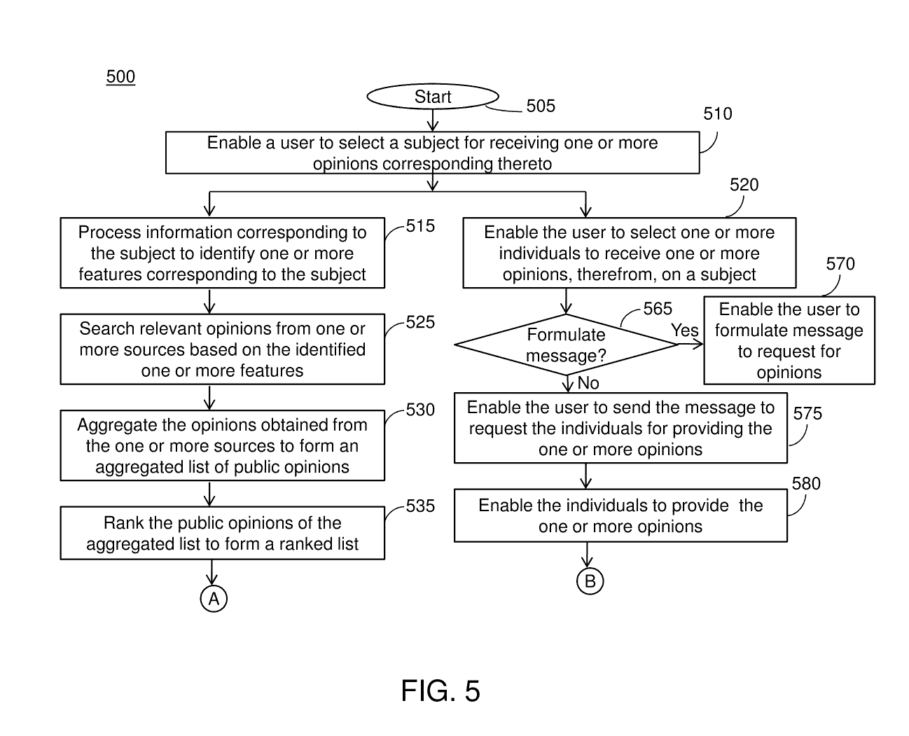

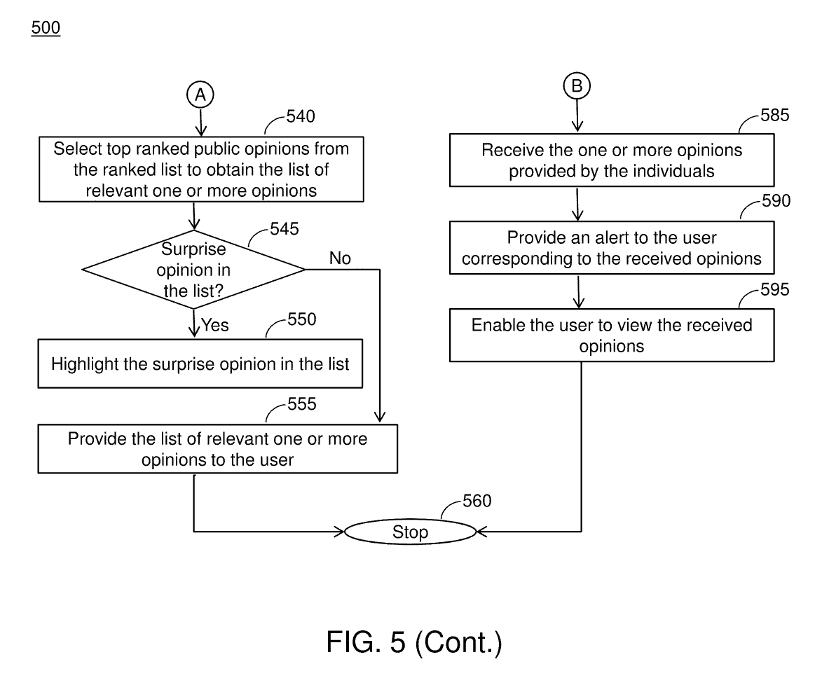

FIG. 5 is a flowchart illustrating a method 500 for obtaining one or more opinions relevant for a subject, in accordance with yet another embodiment of the present disclosure. The FIG. 5 depicts a method that may provide public opinions to a user and may enable the user to obtain one or more opinions relevant for a subject. The method 500 may be understood more clearly when method 300 and method 400 (depicted by FIG. 3 and FIG. 4) are read in conjunction. Further, various steps of the method 500 (as depicted by FIG. 5) performs similar/same functionalities, thus the description for the same is not repeated herein for the sake of brevity. Also, the order and number of steps in which the method 500 is described is not intended to be construed as a limitation.

The method starts at 505. At step 510, the method enables the user to select a subject for receiving opinions corresponding thereto. The opinions may be public opinions or individual specific opinions. The subject may be a recommendation for fulfilling a need of the user. Further, the subject may be of type text, an audio, a video and an image. After selecting the subject, the method 500 may proceed to step 515 and step 520 simultaneously.

At step 515, information corresponding to the subject may be processed to identify one or more features corresponding to the subject. The one or more features may include, but are not restricted to, entities and domains of the subject. This step may be understood further in conjunction with step 410 of FIG. 4. Further, at step 525, the method 500 may search relevant public opinions from one or more public sources based on the identified features. The searching based on the identified features may be understood in conjunction with 415 of FIG. 4.

Further, steps 530, 535, and 540 may be understood when read in conjunction with step 420 in FIG. 4. At step 545, it is determined whether the list of relevant opinions, obtained at step 540, includes a surprise opinion. The surprise opinion may be obtained from one or more public sources without the user's knowledge and source of the surprise opinion is present in contact list maintained by the user. If the list of relevant opinions includes the surprise opinion, then the method proceeds to step 550 (shown by the “Yes” branch from 545). Further, if the list of relevant opinions does not include the surprise opinion, then the method proceeds to 555 (shown by the “No” branch from 545).

At step 550, the method 500 highlights the surprise opinion in the list of relevant opinions. Further, at step 555, the list of relevant opinions may be provided to the user. The step 555 may be understood more clearly in conjunction with step 425 of FIG. 4. Further, at step 560, the method ends.

Simultaneous to step 515, the method 500 may proceed to the step 520. At the step 520, the user may be enabled to select one or more individuals for providing one or more opinions corresponding to the subject (selected at step 510). The individuals may be selected from contact list of the user's profile database that may be maintained by the user or from the user's social network such as from social networking sites like Facebook, Twitter.

Further, the user may be enabled to send a message to the individuals to request the individuals for providing the opinions. The user may be provided with a template message to send the request to the individuals. Further, the user may be enabled to formulate the message. At step 565, it may be determined whether the user wants to formulate a message to request the individuals to provide opinions. If the user wants to formulate the message, then the method proceeds to step 570 (shown by the “Yes” branch from 565). Further, if the user does not want to formulate the message, then the method proceeds to 575 (shown by the “No” branch from 565) in which the message generated by the system may be used.

At step 570, the user may be enabled to formulate the message to request for opinions. In an embodiment, the user may create new templates for the message and may store such templates for future use. Further, the steps 575, 580, 585, 590, and 595 may be understood in conjunction with FIG. 3.

Thus, the method 500 may search for public opinions when the user seeks opinions from the one or more individuals.

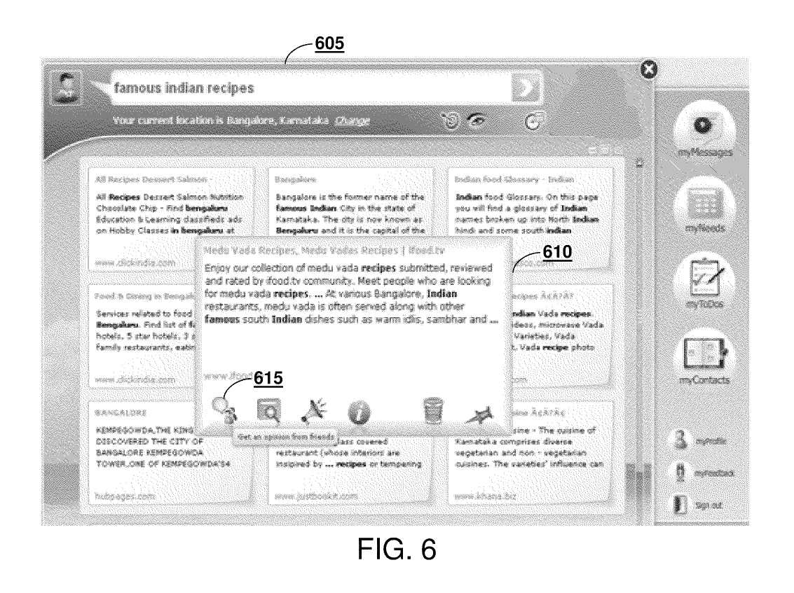

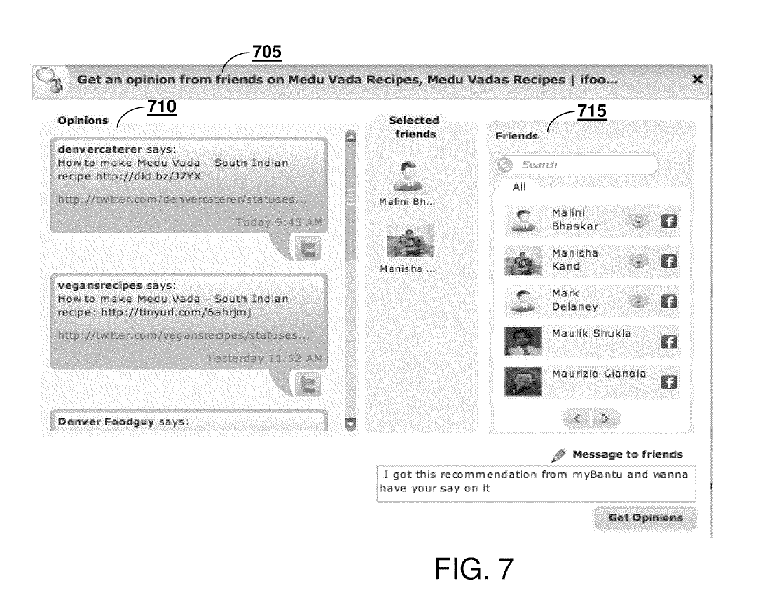

FIG. 6 illustrates an exemplary view of a user interface for enabling a user to select the ‘get opinion’ option corresponding to a subject, in accordance with one embodiment of the present disclosure. FIG. 6 depicts recommendations searched by the user for a need 605. The user may select any recommendation (subject) from the available recommendations such as depicted by 610. For example, as depicted, the need of the user may be to look for ‘famous Indian recipes. Further, the user may select the subject as ‘Medu Vada Recipes’, as shown by 610. For this selected recommendation (subject), the user may get opinion by utilizing an option ‘Get Opinion’ as depicted by 615. On selecting the subject the user may get a Graphical User Interface (GUI) (as depicted in FIG. 7) to enable the user to obtain one or more opinions for the selected subject.

FIG. 7 illustrates an exemplary view of a user interface for enabling a user to select one or more individuals for obtaining opinions therefrom, in accordance with one embodiment of the present disclosure. FIG. 7 depicts a subject in a title 705 for which the user wants to obtain opinions. Further, FIG. 7 depicts public opinions 710 corresponding to the subject. The public opinions may be searched by a system, such as the system 120, as depicted in FIG. 1. Further, the FIG. 7 shows an area 715 for contact list of the user to enable the user to select one or more individuals therefrom. The individuals that may be selected by the user, may further be requested (by the user) to provide opinions corresponding to the subject.

Advantageously, the present disclosure enables the user to obtain opinions from, one or more individuals, corresponding to the subjects. Further, the opinions may be ranked based on the subject. This enables the user to consider the opinion without requiring much filtering to get relevant opinions. Further, it saves the user's time and effort in making a correct decision. Also, the user may receive relevant public opinions based on the user's selection of the subject. The user may obtain the opinions through one or more communication channels such as Email, SMS, Internet and the like. Further, an alert may be provided to the user whenever the user gets opinions corresponding to the subject.

The present invention may also be embodied in a computer program product for obtaining one or more opinions. The computer program product may include a non-transitory computer usable medium having a set program instructions comprising a program code for obtaining one or more opinions relevant for a subject such as a recommendation, audio, text content, video and an image. The set of instructions may include various commands that instruct the processing machine to perform specific tasks such as enabling the user to obtain opinions from one or more individuals relevant to the subject, receiving public opinions from one or more public sources. Further, the opinions may be processed to provide ranking to the opinions. The set of instructions may be in the form of a software program. Further, the software may be in the form of a collection of separate programs, a program module with a large program or a portion of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limit to these embodiments only. Numerous modifications, changes, variations, substitutions and equivalents will be apparent to those skilled in the art without departing from the spirit and scope of the invention, as described in the claims.

The foregoing description sets forth numerous specific details to convey a thorough understanding of embodiments of the invention. However, it will be apparent to one skilled in the art that embodiments of the invention may be practiced without these specific details. Some well-known features are not described in detail in order to avoid obscuring the invention. Other variations and embodiments are possible in light of above teachings, and it is thus intended that the scope of invention not be limited by this Detailed Description, but only by the following Claims.

What is claimed is:

1. A method for obtaining one or more opinions relevant for a subject comprising:
enabling a user to select one or more individuals to receive the one or more opinions therefrom on the subject, the one or more individuals correspond to one or more sources;
enabling the user to send a message to request the one or more individuals for providing the one or more opinions corresponding to the selected subject, the message being sent through one or more communication channels;
enabling the one or more individuals to provide the one or more opinions corresponding to the message;
receiving the one or more opinions provided by the one or more individuals, the one or more opinions being received through the one or more communication channels; and
enabling the user to view the received one or more opinions corresponding to the subject.

2. The method of claim 1, wherein the subject comprises at least one of a recommendation corresponding to a need of the user, a video, an audio, and an image.

3. The method of claim 1 further comprising enabling the user to select the subject from a plurality of available subjects for receiving the one or more opinions on the subject.

4. The method of claim 1 further comprising enabling the user to personalize the message to request for the one or more opinions from the one or more individuals.

5. The method of claim 1 further comprising providing an alert to the user corresponding to the one or more opinions, the alert being provided when the one or more opinions are received from the one or more individuals.

6. The method of claim 1, wherein the one or more individuals are selected from at least one of a social network and a profile database of the user.

7. The method of claim 1 further comprising enabling the user to send additional information corresponding to the one or more opinions.

8. The method of claim 1 further comprising processing the received one or more opinions by performing one or more functionalities thereon, the one of more functionalities being performed to obtain relevant order of the one or more opinions based on relevancy of the one or more opinions corresponding to the subject.

9. The method of claim 1 further comprising recommending the one or more individuals to the user to seek the one or more opinions therefrom, the one or more individuals being recommended to the user when information associated with the one or more individuals corresponds to the subject.

10. A method for obtaining one or more opinions comprising:
enabling a user to select a subject for receiving one or more opinions corresponding thereto;
processing information corresponding to the subject to identify one or more features corresponding to the subject;
obtaining one or more public opinions from one or more sources based on the identified one or more features corresponding to the subject;
processing the one or more public opinions to obtain a list of relevant one or more opinions from the one or more public opinions; and
providing the list of relevant one or more opinions to the user,
wherein a surprise opinion in the provided list of relevant one or more opinions is highlighted, the surprise opinion being provided by an individual corresponding to a social network of the user.

11. The method of claim 10, wherein the one or more features comprise one or more entities and domains corresponding to the subject.

12. The method of claim 10, wherein the one or more public opinions are obtained by searching relevant opinions from the one or more sources based on the identified one or more features.

13. The method of claim 10, wherein processing the one or more public opinions comprises:
aggregating the one or more public opinions obtained from the one or more sources to form an aggregated list of the public opinions; and
ranking the public opinions of the aggregated list to form a ranked list, the public opinions being ranked based on relevancy of each of the public opinions corresponding to the subject; and
selecting top ranked public opinions from the ranked list to obtain the list of relevant one or more opinions.

14. The method of claim 10, wherein the subject comprises at least one of a recommendation corresponding to a need of the user, a video, an audio, and an image.

15. A system for obtaining one or more opinions relevant for a subject comprising:
a selection module configured to enable a user to select one or more individuals to receive the one or more opinions therefrom on the subject, the one or more individuals correspond to one or more sources;
a requesting module for enabling the user to send a message to request the one or more individuals for providing the one or more opinions corresponding to the selected subject, the message being sent through one or more communication channels;
an interaction module for providing one or more options to the one or more individuals, the one or more options being provided for enabling the one or more individuals to provide the one or more opinions corresponding to the message;
a receiving module for receiving the one or more opinions provided by the one or more individuals, the one or more opinions being received through the one or more communication channels; and
an output module for enabling the user to view the one or more opinions corresponding to the subject.

16. The system of claim 15, wherein the subject comprises at least one of a recommendation corresponding to a need of the user, a video, an audio, and an image.

17. The system of claim 15, wherein the selection module is further configured to enable the user to select the subject from a plurality of available subjects for receiving the one or more opinions on the subject.

18. The system of claim 15, wherein the requesting module is further enables the user to personalize the message to request for the one or more opinions from the one or more individuals.

19. The system of claim 15, wherein the output module is further configured to provide an alert to the user corresponding to the one or more opinions, the alert being provided when the one or more opinions are received from the one or more individuals.

20. The system of claim 15, wherein the selection module enables the user to select the one or more individuals from at least one of a social network and a profile database of the user.

21. The system of claim 15, wherein the requesting module enables the user to send additional information corresponding to the one or more opinions.

22. The system of claim 15 further comprising a relevancy module to obtain relevant order of the one or more opinions based on relevancy of the one or more opinions corresponding to the subject, the relevant order of the one or more opinions being obtained by performing one or more functionalities thereon.

23. The system of claim 15, wherein the selection module further configured to provide recommendations to the user for recommending the one or more individuals to seek the one or more opinions therefrom, the one or more individuals being recommended to the user when information associated with the one or more individuals corresponds to the subject.

24. A system for obtaining one or more opinions relevant for a subject comprising:
a selection module for enabling a user to select the subject for receiving one or more opinions corresponding thereto;
a processing module configured to:
process information corresponding to the subject to identify one or more features corresponding to the subject; and
obtain one or more public opinions from one or more sources based on the identified one or more features corresponding to the subject;
a relevancy module configured to obtain a list of relevant one or more opinions from the one or more public opinions, the list of relevant one or more opinions being obtained by performing one or more functionalities on the one or more public opinions; and
an output module configured to provide the list of relevant one or more opinions to the user,
wherein a surprise opinion in the provided list of relevant one or more opinions is highlighted, the surprise opinion being provided by an individual corresponding to a social network of the user.

25. The system of claim 24, wherein the one or more features comprise one or more entities and domains corresponding to the subject.

26. The system of claim 24, wherein the processing module obtains the one or more public opinions by searching relevant opinions from the one or more sources based on the identified one or more features.

27. The system of claim 24, wherein the relevancy module performs the one or more functionalities on the one or more public opinions by:
aggregating the one or more public opinions obtained from the one or more sources to form an aggregated list of the public opinions; and
ranking the public opinions of the aggregated list to form a ranked list, the public opinions being ranked based on relevancy of each of the public opinions corresponding to the subject; and
selecting top ranked public opinions from the ranked list to obtain the list of relevant one or more opinions.

28. The system of claim 24, wherein the subject comprises at least one of a recommendation corresponding to a need of the user, a video, an audio, and an image.

29. A computer program product for use with a computer, the computer program product comprising a non-transitory computer usable medium having a computer readable program code embodied therein for obtaining one or more opinions relevant for a subject, the computer readable program code when executed performing a method comprising:
enabling a user to select one or more individuals to receive the one or more opinions therefrom on the subject, the one or more individuals correspond to one or more sources;
enabling the user to send a message to request the one or more individuals for providing one or more opinions corresponding to the selected subject, the message being sent through one or more communication channels;
enabling the one or more individuals to provide the one or more opinions corresponding to the message;
receiving the one or more opinions provided by the one or more individuals, the one or more opinions being received through the one or more communication channels; and
enabling the user to view the received one or more opinions corresponding to the subject.

30. The computer program product of claim 29, wherein the subject comprises at least one of a recommendation corresponding to a need of the user, a video, an audio, and an image.

31. The computer program product of claim 29, wherein the computer program code further enables the user to select the subject from a plurality of available subjects for receiving the one or more opinions on the subject.

32. The computer program product of claim 29, wherein the computer program code further enables the user to personalize the message to request for the one or more opinions from the one or more individuals.

33. The computer program product of claim 29, wherein the computer program code further performs providing an alert to the user corresponding to the one or more opinions, the alert being provided when the one or more opinions are received from the one or more individuals.

34. The computer program product of claim 29, wherein the one or more individuals are selected from at least one of a social network and a profile database of the user.

35. The computer program product of claim 29, wherein the computer program code further performs enabling the user to send additional information corresponding to the one or more opinions.

36. The computer program product of claim 29, wherein the computer program code further performs processing the received one or more opinions by performing one or more functionalities thereon, the one of more functionalities being performed to obtain relevant order of the one or more opinions based on relevancy of the one or more opinions corresponding to the subject.

37. The computer program product of claim 29, wherein the computer program code further performs recommending the one or more individuals to the user to seek the one or more opinions therefrom, the one or more individuals being recommended to the user when information associated with the one or more individuals corresponds to the subject.
